(19) United States
(12) Patent Application Publication
(10) Pub. No.: US 2023/0259632 A1
(43) Pub. Date: Aug. 17, 2023

(54) RESPONSE ACTIVITY-BASED SECURITY COVERAGE MANAGEMENT

(71) Applicant: Microsoft Technology Licensing, LLC, Rechmond, WA (US)

(72) Inventors: Ron Moshe MARCIANO, Ashqelon (IL); Moshe ISRAEL, Ramat-Gan (IL); Lilyan COHEN, Tel Aviv (IL); Michael GLADISHEV, Kfar Saba (IL); Ziv CIZER, Ness Ziona (IL); Amir SASSON, Tel Aviv (IL); Netanel COHEN, Beer Sheva (IL)

(21) Appl. No.: 17/670,488

(22) Filed: Feb. 13, 2022

(51) Int. Cl. G06F 21/57

(52) U.S. Cl. CPC G06F 21/577; G06F 2221/034

(57) ABSTRACT

Some embodiments gather security activity data from multiple environments instead of only a single environment. Activity data includes alerts, anomaly detections, and defensive actions taken automatically, in response to actual or simulated attacks. Data is cloaked to protect privacy. Security product coverage of techniques, tactics, procedures, threat categories, and other constituents of a cyberattack model is derived from the activity data via a mapping mechanism, allowing subsequent product installation or operation changes to be based on actual recorded responses of products to attacks. Coverage results may be operationalized as recommendations or proactive automated initiatives, for example. Security is enhanced on the basis of data which extends beyond the data available to any single cloud tenant.

### BACKGROUND

Attacks on a computing system may take many different forms, including some forms which are difficult to predict, and forms which may vary from one situation to another. Accordingly, one of the guiding principles of cybersecurity is “defense in depth”. In practice, defense in depth is often pursed by forcing attackers to encounter multiple different kinds of security mechanisms at multiple different locations around or within the computing system. No single security mechanism is able to detect every kind of cyberattack, or able to end every detected cyberattack. But sometimes combining and layering a sufficient number and variety of defenses will deter an attacker, or at least limit the scope of harm from an attack.

To implement defense in depth, cybersecurity professionals consider the different kinds of attacks that could be made against a computing system. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place. Some defenses might not be feasible or cost-effective for the computing system. However, improvements in cybersecurity remain possible, and worth pursuing.

### SUMMARY

Some embodiments described herein identify gaps in cybersecurity coverage, and document the coverage gaps in terms of one or more cyberattack models such as the MITRE ATT&CK® model (mark of The MITRE Corporation), the CYBER KILL CHAIN® model (mark of Lockheed Martin Corporation), or the STRIDE™ threat model (mark of Microsoft Corporation), for example. Some embodiments identify duplicate cybersecurity coverage, by revealing that two security products are both covering the same attacker tactics or the same attacker techniques. Some embodiments estimate the security coverage impact of a prospective change in which a security product would be installed or a security product’s operational configuration would be changed. Security coverage change estimates are based on observations of how security products actually respond to attacks in various environments. This permits security decisions to be based on a product’s performance instead of relying on product documentation or on product reviewer conclusions.

Some embodiments manage cybersecurity coverage in an observed computing system which includes multiple environments, e.g., multiple customer environments in a cloud or a data center. These embodiments gather security activity data produced by at least two concurrently functional installations of a security product, with each installation installed in a different respective environment of the observed computing system. Thus, the security activity observations extend beyond any single cloud customer’s environment, for example. The embodiments derive a security coverage map data structure from the gathered security activity data, by attempting to match gathered security activity data to cybersecurity attack model constituents such as tactics, techniques, procedures, or threat categories. Matches indicate coverage, and the absence of any matches indicates a coverage gap.

The resulting security coverage map may be operationalized in various ways to enhance cybersecurity. For example, coverage gaps may be filled by reconfiguring a security product or by installing a new product. Coverage duplication may be reduced by product reconfiguration or de-installation. Legal or policy requirements may be satisfied by documentation generated from the coverage map. Products that perform well in a similar environment may be installed in a given environment with confidence they will provide desired coverage, and products which do not meet desired coverage criteria may be identified and avoided in a particular environment without first being installed there to see how they perform. Other aspects of security coverage management functionalities are also described herein.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce – in a simplified form – some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems and also illustrating configured storage media;

FIG. 2 is a block diagram illustrating aspects of a computing system which has one or more of the security coverage management enhancements taught herein;

FIG. 3 is a block diagram illustrating an enhanced system configured with security coverage management functionality;

FIG. 4 is a block diagram illustrating aspects of some mapping mechanisms suitable for computationally mapping between cyberattack model constituents and security activity data;

FIG. 5 is a block diagram illustrating aspects of some security coverage maps;

FIG. 6 is a block diagram illustrating aspects of some computing environments in which security activity is observed;

FIG. 7 is a block diagram illustrating aspects of some security activity data;

FIG. 8 is a flowchart illustrating steps in some security coverage management methods;

FIG. 9 is a flowchart further illustrating steps in some security coverage management methods, incorporating FIG. 8; and

FIG. 10 shows a stylized user interface for a security coverage management program.

### DETAILED DESCRIPTION

### Overview

In this disclosure, “product” means a security product or a security service, “cybersecurity” is used interchangeably with “security”, “cyberattack” is used interchangeably with “attack”, “attack framework” is used interchangeably with “attack model”, “SIEM” stands for “security information and event management”, and “SOC” stands for “security operations center”. A “coverage map” represents not only what attack framework constituents are covered by one or more products, but also what is not covered, e.g., which aspects of various attacks are protected against and which are not, based on available data representing product behavior in response to an attack.

Innovations may expand beyond their origins, but understanding an innovation’s origins can help one more fully appreciate the innovation. In the present case, some teachings described herein were motivated by technical challenges arising from a goal of improving Microsoft Sentinel® SIEM integration with the MITRE ATT&CK® model, in Azure® clouds and other computing environments (MITRE ATT&CK® is a mark of The MITRE Corporation; Sentinel® and Azure® are marks of Microsoft Corporation).

In particular, the innovators observed that the techniques enumerated in the attack framework were all treated as equals. In practice, this led SOC personnel to rely on personal intuition or other subjective factors as they tried to prioritize efforts during an attack, or when they analyzed the attack and their responses to it later. Although personal security training and experience are often enormously helpful, they can also be very subjective in their results. Subjectivity can lead to inconsistencies in incident responses, or to missed opportunities. Sometimes automated responses would have been swift enough to reduce or prevent harms that occurred when slower subjective approaches were employed.

The innovators also observed that integration between SIEMs and attack frameworks was generally ad hoc and limited. Some SIEMs or other tools indicated coverage of attack tactics but not coverage of attack techniques or other framework constituents. Some tools relied on a workbook approach that does not adequately support automated proactive security actions in response to an attack. Most if not all coverage descriptions were focused on a single attack framework instead of permitting users to select from several frameworks.

The innovators also observed that indications of an entity’s security coverage relative to a framework were limited by the data available to the entity. In the cloud, this meant that a given business, agency, or other entity generally focused on making the best use of their own SIEM data, because that was the only SIEM data available to them. SIEM data which did not originate with or otherwise belong to the entity in question was not readily available to the entity. SIEM data from other entities was generally unavailable. The sharing of security-related data between entities was generally limited to authentication federation, reports to regulatory agencies, broad statistics, or similar tightly constrained circumstances.

The innovators also observed that security product behavior does not always conform with product documentation, or with online product reviews. The people who write documentation or product reviews often rely on what they are told by other people, because it is usually not practical to install a complex product and explore all of the product’s behaviors oneself with the limited time and resources available to a documentation or review author. Security product documentation often lags behind product changes, even when products behave as designed. Accordingly, documentation and product reviews are sometimes incomplete or inaccurate.

The innovators conceived and designed security coverage management advances in response to these observations, and to address these and other technical challenges related to coverage by cybersecurity products.

For example, a challenge of obtaining accurate descriptions of security product behavior is addressed by gathering security activity data from multiple environments and mapping that activity data to one or more attack frameworks. The resulting information about a security product’s coverage of particular attack tactics or attack techniques therefore arises from the product’s actual behavior in response to attacks. Instead of relying on documentation or reviews, a human decisionmaker or an automated cyberdefense system can utilize a security coverage map that is as up-to-date, and as accurate, as the observed behavior the coverage map is based on.

A challenge of getting accurate security coverage information about products that are not yet installed in one’s own environment is likewise addressed by gathering security activity data from other environments and deriving a coverage map from it. Appropriate privacy protections are employed. As a result, buying a product and installing it is no longer the only reliable way to determine what security coverage the product will provide. The behavior of the product in other environments, together with assessments of the similarities or differences between the environments, provides a data-driven basis for accurately and cost-effectively predicting how the addition of the product to an environment will change the security coverage provided in that environment.

A challenge of more fully integrating a SIEM with one or more attack frameworks is addressed by using mapping mechanisms that correlate security activity data with the constituents (e.g., the tactics, techniques, procedures, or threat categories) of one or more frameworks. By providing activity-to-constituent correspondence data structures in a given mapping mechanism, all framework constituents of interest can be integrated with a SIEM. For example, coverage of both the tactics and the techniques of the MITRE ATT&CK® framework may be determined and displayed (mark of The MITRE Corporation). By providing additional framework-specific mapping mechanisms, additional frameworks can be similarly integrated in a given SIEM, e.g., coverage can be assessed per both the MITRE ATT&CK® framework and the CYBER KILL CHAIN® model (mark of Lockheed Martin Corporation). The mapping mechanism can also associate 946 priorities 418 with framework constituents, instead of treating every tactic as equal to every other tactic, for example. Priorities may be set by an admin, e.g., or correspond to the frequency with which a constituent 304 appears in security activity data 226. The mapping mechanism can also associate activity data 226 with framework constituents to indicate which attack model constituents 304 are employed by which adversaries, e.g., adversary APTBadGuy often employs techniques T23 and T14 and has never been shown to employ technique T13.

More generally, the present disclosure provides technical mechanisms to address these and other challenges, in the form of various security coverage management functionalities. These functionalities may be used in various combinations with one another, or alone, in a given embodiment.

### Operating Environments

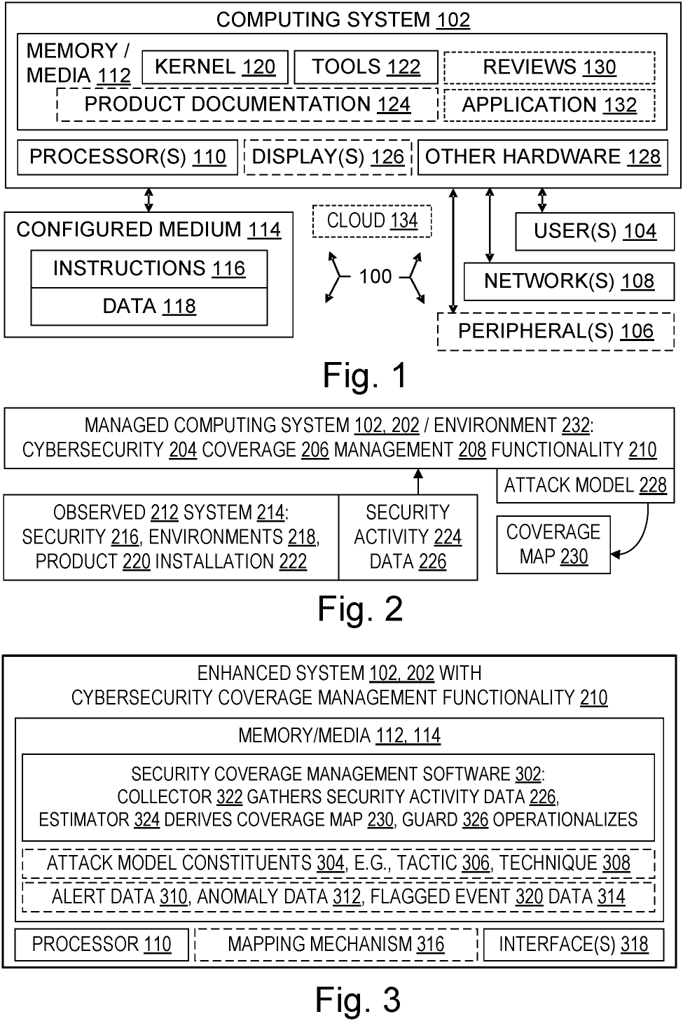

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 134. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. Virtual reality or augmented reality or both functionalities may be provided by a system 102. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of human user 104. Automated agents, scripts, playback software, devices, and the like running or otherwise serving on behalf of one or more humans may also have accounts, e.g., service accounts. Sometimes an account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a cloud 134 and/or other network 108 via network interface equipment, for example.

Each computer system 102 includes at least one processor 110. The computer system 102, like other suitable systems, also includes one or more computer-readable storage media 112, also referred to as computer-readable storage devices 112. Product documentation 124 or product reviews 130 may reside in media 112 within a system 102 that hosts or contains or communicates with the product that is documented or reviewed, or may reside outside that system 102.

Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs, GPUs, and/or quantum processors), memory / storage media 112, peripherals 106, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, security coverage management functionality could be installed on an air gapped network and then be updated periodically or on occasion using removable media 114. A given embodiment may also communicate technical data and/or technical instructions through direct memory access, removable or non-removable volatile or nonvolatile storage media, or other information storage-retrieval and/or transmission approaches.

One of skill will appreciate that the foregoing aspects and other aspects presented herein under “Operating Environments” may form part of a given embodiment. This document’s headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

### More About Systems

FIG. 2 illustrates a computing system 102 configured by one or more of the security coverage management enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an enhanced system 202 which is configured with security coverage management software 302 to provide security coverage management functionality 210. FIG. 3 items are discussed at various points herein, and additional details regarding them are provided in the discussion of a List of Reference Numerals later in this disclosure document.

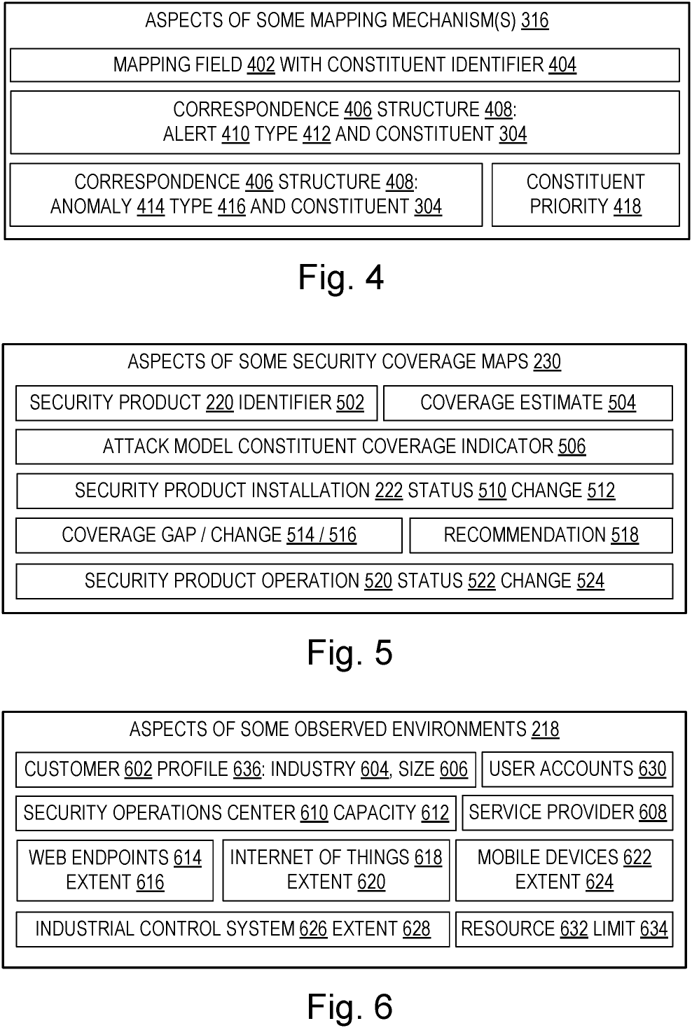

FIG. 4 shows some aspects of mechanisms 316 for mapping between security activity data 226 and attack framework constituents 304. This is not a comprehensive summary of all mapping mechanisms 316 or of every attack framework constituent 304. FIG. 4 items are discussed at various points herein, and additional details regarding them are provided in the discussion of a List of Reference Numerals later in this disclosure document.

FIG. 5 shows some aspects of security coverage maps 230, which take the form of data structures in a system 102. This is not a comprehensive summary of all security coverage maps 230. FIG. 5 items are discussed at various points herein, and additional details regarding them are provided in the discussion of a List of Reference Numerals later in this disclosure document.

FIG. 6 shows some aspects of observed computing environments 218. These are computing environments 100 in which security activity 224 regarding one or more observed systems 214 has been “observed”, in the sense that data 226, 118 representing security activity 224 has been generated, copied, or otherwise gathered 802. The discussion of security coverage management herein also refers to managed computing systems 202, which are computing systems 102 for which a coverage map 230 has been or is being derived 804 based on gathered security activity data 226. The managed computing system 202 could be part of the observed computing system 214, or it could be separate, depending on the scenario. Similarly, the security products 220 being checked for coverage might provide some coverage for the managed computing system, or they might not.

More generally, at least four relationships are potentially present between managed systems 202 and observed systems 214 (or likewise between a managed environment 232 and an observed environment 218). The one or more managed computing systems 202 and the one or more observed computing systems 214 may (a) be completely distinct from each other, or may (b) partially overlap, or may (c) be coextensive, or (d) one may be contained in the other.

For example, in a relationship (a) a coverage map may represent the likely coverage of a managed system M by a product P based on P’s activity covering (or failing to cover) an observed system O, where M and O are two distinct servers operated respectively by different unaffiliated businesses, and where P is installed on O but is not installed on M.

In a relationship (b) a coverage map may represent the actual coverage of a managed system M by a product P based on P’s activity covering (or failing to cover) both M and an observed system O, where M and O are two servers operated respectively by different unaffiliated businesses, and P is installed both on O and on M. If attacks against O have been more frequent than attacks against M, for instance, then considering the O activity data may be more accurate than coverage conclusions that are based solely on data about attacks against M. Perhaps P does not do as well under a heavier attack. Or, perhaps P is better at detecting larger attacks than P is at detecting smaller attacks.

In a relationship (c) a coverage map may represent the actual coverage of a managed system M by an installed product P based on P’s activity covering (or failing to cover) M. That is, in this example M is both the observed system and the managed system.

In a relationship (d) a coverage map may represent the actual coverage of an entire managed system M by a product P based on P’s activity covering (or failing to cover) a portion of M; the portion nominally covered is the observed system O. For instance, P might be configured to perform exfiltration detection only against a research and development department O, and the coverage map might be used to assess the option of reconfiguring P to cover all departments.

The foregoing are merely examples, not a comprehensive summary of all relationships between a managed system 202 and an observed system 214. FIG. 6 items are discussed at various points herein, and additional details regarding them are provided in the discussion of a List of Reference Numerals later in this disclosure document.

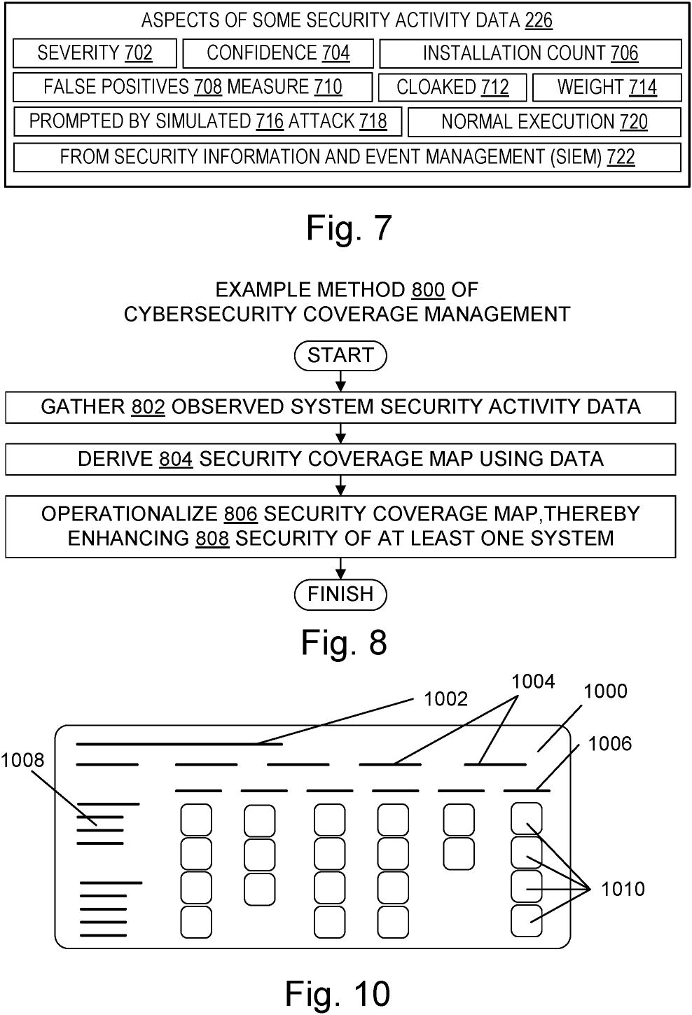

FIG. 7 shows some aspects of security activity data 226. This is not a comprehensive summary of all security activities 224 or of all data 226 which represents a security activity 224. FIG. 7 items are discussed at various points herein, and additional details regarding them are provided in the discussion of a List of Reference Numerals later in this disclosure document.

In some embodiments, the enhanced system 202 may be networked through an interface 318. An interface 318 may include hardware such as network interface cards, software such as network stacks, APIs, or sockets, combination items such as network connections, or a combination thereof.

In some embodiments, the enhanced system 202 includes a managed computing system 202 which is configured for managing cybersecurity coverage 206. The enhanced system 202 includes a digital memory 112 and a processor 110 in operable communication with the memory. The digital memory 112 may be volatile or nonvolatile or a mix. The processor 110 is configured to perform cybersecurity coverage management steps. The steps include (a) gathering 802 security activity data 226 produced by at least two concurrently functional installations 222 of a security product 220, each installation installed in a different respective environment 218 of an observed computing system 214, each said environment holding data of exactly one entity 602, (b) deriving 804 a security coverage map 230 from the gathered security activity data, the deriving including attempting 912 to match 914 at least a portion of the gathered security activity data 226 to at least one cybersecurity attack model constituent 304, and (c) operationalizing 806 the security coverage map, thereby enhancing 808 cybersecurity 216 of at least one computing system.

In some embodiments, the managed computing system further includes the gathered security activity data 226, and the gathered security activity data includes at least one of the following: security alert 410 data 310, security anomaly 414 data 312, or flagged security event 320 data 314.

In some embodiments, the managed computing system further includes an attack model data structure 228 representing a cybersecurity attack model which includes multiple cybersecurity attack model constituents 304.

In some embodiments, the managed computing system further includes an attack model data structure 228 representing a cybersecurity attack model which includes both technique constituents 308, 304 and tactic constituents 306, 304.

Various mechanisms 316 may be employed for mapping from activity data 226 to attack model constituents 304, e.g., from alerts 410 to tactics 306 and techniques 308. One possibility is that the alert 410 includes a technique number 404 or a tactic number 404 that can be extracted by a parser from an alert field 402. Another possibility is that a correspondence” data structure 408 provides the mapping. A database is one example of a correspondence structure 408, as it can be configured with data 118 that represents a correspondence between activity data 226 and attack model constituents 304. A spreadsheet is a kind of database; a relational database is another. A table that is not necessarily part of a database, and a set of key-value pairs, would be two other examples of a correspondence structure 408.

In some embodiments, the managed computing system further includes a mapping mechanism 316 which includes at least one of the following: a mapping field 402 in the gathered security activity data 226 which contains a cybersecurity attack model constituent identifier 404; a correspondence structure 408 which represents a correspondence between an alert type 412 and a cybersecurity attack model constituent 304 (e.g., per a database 408 an alert type X matches at least technique Y or matches at least tactic Z, or both); or a correspondence structure 408 which represents a correspondence between an anomaly type 416 and a cybersecurity attack model constituent 304 (e.g., per a database 408 an anomaly type X matches at least technique Y or matches at least tactic Z, or both).

In some embodiments, the coverage map identifies a security product and then (a) tells how much coverage the product provides where it’s been installed (without identifying any particular installed location) or (b) predicts how much coverage the product would provide in an environment that does not currently have the product installed, or both.

In some embodiments, the managed computing system further includes the security coverage map 230, and the security coverage map includes a security product identifier 502 which identifies the security product 220. The security coverage map also includes at least one of: a cybersecurity attack model constituent coverage indicator 506 which indicates an extent to which the security product covers the cybersecurity attack model constituent in the environments 100 which include the concurrently functional installations of the security product, or an estimate 504 of an extent to which the security product would cover the cybersecurity attack model constituent in an environment which does not include any concurrently functional installation of the security product.

Other system embodiments are also described herein, either directly or derivable as system versions of described processes or configured media, duly informed by the extensive discussion herein of computing hardware.

Although specific security coverage management architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different security products 220, for example, as well as other technical features, aspects, mechanisms, rules, operational sequences, data structures, environment or system characteristics, or other security coverage management functionality teachings noted herein, and may otherwise depart from the particular illustrative examples provided.

### Processes (A.K.A. Methods)

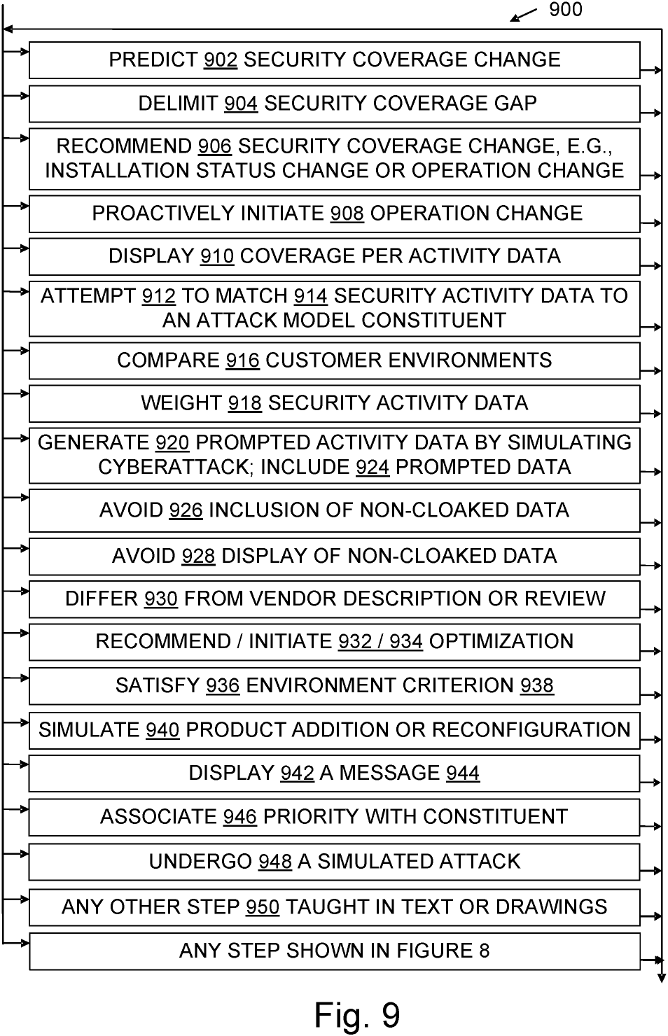

Methods (which may also be referred to as “processes” in the legal sense of that word) are illustrated in various ways herein, both in text and in drawing figures. FIGS. 8 and 9 illustrate families of methods 800, 900 that may be performed or assisted by an enhanced system, such as system 202 or another functionality 210 enhanced system as taught herein. FIG. 9 includes some refinements, supplements, or contextual actions for steps shown in FIG. 8, and incorporates the steps of FIG. 8 as options.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human may select a product 220 name from a menu or select several tactics, techniques, procedures, threat categories, or other constituents 304 from a visualization of an attack model 228; these human activities may then be represented electronically by the computer as data 118. But no process contemplated as innovative herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIGS. 8 and 9. Arrows in method or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 800 or 900 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments use or provide a method 900 for security coverage management, the method performed by a computing system, the method including: gathering 802 security activity data 226 produced by at least two concurrently functional installations 222 of a security product 220, each installation installed in a different respective environment 100, 218 of an observed computing system 214; deriving 804 a security coverage map 230 from the gathered security activity data, the deriving including attempting 912 to match 914 at least a portion of the gathered security activity data 226 to at least one cybersecurity attack model constituent 304; and operationalizing 806 the security coverage map, thereby enhancing 808 cybersecurity of the observed computing system 214, a managed computing system 202, or both systems.

One of skill informed by the teaching herein will understand various ways to enhance 808 security 216 based on the security coverage map 230. In some embodiments, operationalizing 806 the security coverage map includes at least one of the following particular operationalizations.

Operationalization 806 may include predicting 902 a security coverage change 516 based on the security coverage map 230 and a specified change 512 to a security product installation status 510 in a particular environment. For instance, an embodiment may display 942 a message 944 to the effect of “this is how coverage will probably change if you install this product”. Simulating 940 the addition or reconfiguration of a security product is an example of predicting a security coverage change.

Operationalization 806 may include delimiting 904 a gap 514 in security coverage 206 based on the security coverage map. For instance, an embodiment may display 942 a message 944 to the effect of “Environment E1 is not covering these tactics: Lateral Movement, Persistence”, or a message 944 to the effect of “None of the environments are covering this technique: Sudo and Sudo Caching”.

Operationalization 806 may include recommending 906 a security coverage change 516 based on the security coverage map 230. For instance, an embodiment may display 942 a message 944 to the effect of “It would be prudent to also cover this tactic: Exfiltration”, or a message 944 to the effect of “You could save by removing the duplicate coverage of this technique: Account Discovery”.

Operationalization 806 may include recommending 906 a security product installation status change 512 based on the security coverage map. For instance, an embodiment may display 942 a message 944 to the effect of “You should install product ContosoGuard or ContosoShield to cover the gap”. These are not actual products; Contoso Corporation and Fabrikam, Inc. are fictional companies which appear in the present disclosure in order to help illustrate coverage situations by discussing hypothetical products or services based on those fictional company names, such as ContosoGuard, ContosoSentry, FabrikamAV, etc.

Operationalization 806 may include proactively initiating 908 a security product operation status change 524 or a security product installation status change 512, or both changes, based on the security coverage map 230. For instance, an embodiment may proactively and automatically enable a product ContosoSentry to close a newly found coverage gap 514. This may include launching ContosoSentry, or reconfiguring ContosoSentry to change its behavior, for example. Or an embodiment may proactively download and install a product 222. Such proactive automatic protections may prevent harms that would have occurred if contemporaneous human action was instead required.

Operationalization 806 may include displaying 910 a security coverage 206 of a specified security product 220, wherein the security coverage is derived 804 from the gathered security activity data 226 as opposed to being based on product documentation 124 or on human-created product reviews 130. For example, an embodiment may show FabrikamAV 220 coverage 206 based on alerts 410, not based on a FabrikamAV user manual 124 or on FabrikamAV marketing literature 130 or blog articles 130 about FabrikamAV.

Operationalization 806 may include displaying 910 a security coverage 206 of the cybersecurity attack model constituent 304, wherein the security coverage is derived 804 from the gathered security activity data 226 as opposed to being based on product documentation 124 or on human-created product reviews 130. For example, an embodiment may show coverage 206 by a ContosoSecuritySuite product for all MITRE ATT&CK® enterprise tactics 304, 306 or enterprise techniques 304, 308, with the shown coverage being based on alerts 410, not on any ContosoSecuritySuite user manual or on marketing literature or blog articles about ContosoSecuritySuite (MITRE ATT&CK® is a mark of The MITRE Corporation; ContosoSecuritySuite is fictional).

Some embodiments address the risk that a product 220 may behave quite differently in different environments 218. If two environments 218 are too different in particular ways, then the coverage 206 given by a product in one environment might not be reproduced in a different environment. Ways that customer environments 218 may differ can be characterized using a customer profile 636 data structure.

In some embodiments, operationalizing 806 the security coverage map includes comparing at least two customer environments 218 with respect to at least one of the following characteristics: a customer industry 604, a customer size 606, a customer security operations center capacity 612, an extent 616 of web endpoints 614 in an environment, an extent 620 of internet of things devices 618 in an environment, an extent 624 of mobile devices 622 in an environment, an extent 628 of industrial control systems 626 in an environment, a presence or an absence of a particular application 132 in an environment, or a cloud service provider 608 utilized in an environment.

Some embodiments weight 918 particular data items 226 to help control the quality of the security coverage map. Filtering is a particular kind of weighting, since filtering effectively gives an item a weight of zero by excluding it or a weight of one by including it. Another kind of weighting is multiplying by some value x, with 0 < x < 1.

In some embodiments, deriving 804 the security coverage map includes at least one of the following: weighting 918 at least a portion of the gathered security activity data based on a severity measure 702 (e.g., information-only alerts are weighted to not count toward coverage because they are not severe enough); weighting 918 at least a portion of the gathered security activity data based on a confidence measure 704 (e.g., alerts given a low confidence by the tool that detects them count for less as evidence of coverage); weighting 918 at least a portion of the gathered security activity data based on a false positives measure 710 (spraying lots of false positive alerts will not increase a product’s coverage level in the coverage map); or weighting 918 at least a portion of the gathered security activity data based on an installation count 706 (e.g., an alert is considered as evidence of coverage only if it was observed coming from the product as installed in at least in five different customer environments, or at least three environments, or some other minimum installation count that is set by an admin or based on a feedback loop).

Some embodiments provide useful coverage maps regardless of what actors provoked the security activities 224 whose data 226 are leveraged by the embodiment. The data 226 may result from attacks by malicious parties, from inadvertent actions by non-malicious parties, or from simulated attacks by non-malicious parties, for example. In particular penetration testing or other simulated attacks may result in security activity data 226 that can be a basis for at least part of a coverage map 230. A “simulated” attack against a customer’s environment is an attack that is authorized in advance by the customer 602. The “customer” may be a business entity, an educational institution, a research facility, a government agency, or another legal or juristic person, for example. However, an individual human does not constitute a customer 602.

In some embodiments, the method includes generating 920 at least a prompted portion of the security activity data 226 by undergoing 948 a simulated 716 cyberattack, and including 924 at least part of the prompted portion in the gathered security activity data.

The security activity data 226 usable for deriving 804 a coverage map is not limited to the data of a sole entity. Rather, data 226 from multiple entities’ respective environments 218 may be gathered 802 and used as a basis for a coverage map 230. Accordingly, it is presumed that appropriate legal agreements and technical controls will be employed to prevent misappropriation or misuse of data 226.

Some embodiments provide particular ways to protect customer privacy, such as cloaking 712 which products 220 are installed in which environment 218. Some examples of cloaking 712 include anonymization, pseudonymization, data masking, encryption, filtering, and blocking. In general, only the environment-product data for other customers is cloaked from a given customer; each customer can see their own environment-product data. Other customer-specific proprietary or confidential data fields 402 can also be cloaked.

In some embodiments, the method includes cloaking 712 environment-product data 510, wherein the environment-product data states that a given security product 220 is installed in a given customer environment 218 other than a given customer’s own customer environment. In some of these, the cloaking 712 includes at least one of the following: cloaking at least a portion of the environment-product data prior to finishing gathering 802 security activity data (e.g., an embodiment may cloak data before gathering or as it is being gathered); cloaking at least a portion of the environment-product data in the gathered security activity data (e.g., cloak data as soon as feasible after it is gathered); avoiding 926 inclusion of any non-cloaked environment-product data in the security coverage map (e.g., build the coverage map using pseudonymized data such as Cust0001, Cust0002 instead of actual customer names); or avoiding 928 displaying any non-cloaked environment-product data during normal execution (e.g., use actual customer names internally within memory 112 during map derivation 804 but don’t print those names or display 126 them; this approach does not necessarily prevent access to customer names or other unencrypted data via a memory dump or a debugger).

Various architectures may be utilized when gathering 802 the security activity data. One suitable architecture includes a cloud-wide service provider infrastructure program 302, e.g., a single SIEM that monitors activities 224 of multiple customers. Environment-specific SIEMS 302 or agents 302 could also send activity data to a cloud-wide SIEM 302. Another suitable architecture includes individual programs 302 in each customer environment, e.g., SIEM S1 in environment E1, SIEM S2 in environment E2, and several programs 122 in E3 (e.g., E3 may have an intrusion detection system, an exfiltration monitor, and an anti-virus program).

A SIEM 722 is a non-specialized security product 220. Some examples of specialized security products 220 include anti-virus software, firewalls, packet sniffer software, intrusion detection systems, and intrusion prevention systems.

In some embodiments, gathering 802 security activity data includes at least one of the following: gathering security activity data from a security information and event management system 722 which monitors activities 224 in multiple environments 218 (e.g., cloud-wide SIEM); gathering security activity data from each of a plurality of agents or security information and event management systems which each monitor activities in a respective single environment (e.g., one SIEM per environment, potentially from different vendors); or gathering security activity data from at least one specialized security product which monitors activities in a single environment (e.g., an intrusion detection system or an antivirus service).

In some circumstances, a cloud service provider 608 uses the activity data 226 of its cloud customers collectively to improve individual customer security 216. In some, an environment-specific SIEM provider of multiple installations 222, an industry association, a regulatory agency, or another entity with legal access to data 226 of association of entities may use telemetry 226 from multiple entities 602 to evaluate security product effectiveness or to find coverage gaps, by applying the teachings disclosed herein.

In some embodiments, the method 900 is performed by, or on behalf of, a cloud service provider 608 which provides services to customers 602 in a cloud 134, and the environments 218 from which data 226 is gathered include customer environments in the cloud.

One of skill in the art, particularly one having many years of security experience, may appreciate that differences between actual coverage by a product 220 and the security product’s documentation can be discovered by applying the teachings disclosed herein. The difference could go in either direction, e.g., it may be that a product manual 124 says constituent X is covered but the data-based coverage map 230 indicates X is not covered, or it may be that the product manual doesn’t mention X but the coverage map indicates constituent X is being covered.

Product manuals 124 are examples of vendor descriptions of products 220 (or services, since security services are treated herein as products 220). A “vendor description” 124 of a security product 220 is a written (paper, website, PDF, etc.) description of the security product that has been published, assented to, authorized, or otherwise approved by the vendor of the security product. This includes some but not necessarily all product reviews 130, because vendors may approve of some reviews but not others.

In some embodiments and circumstances, for a particular security product 220, the coverage map 230 differs 930 from a vendor description 124 of the particular security product as to whether a particular cybersecurity attack model constituent 304 is covered 206 by the particular security product.

Some embodiments can respond dynamically to changes in a security landscape. Such flexibility is beneficial because for most if not all entities, it is not realistic to have all security products fully on all the time because that would cost too much, in terms of computational resources or money or both. That is, many if not all security product operations have a resource constraint 634 which imposes limits on compute, storage, network, personnel, estimated financial cost, or other resources 632.

In some embodiments, operationalizing 806 the security coverage map includes at least one of the following: recommending 932 a security product status 510, 522 optimization based on at least the security coverage map 230 and a resource constraint 634 (a message to the effect that “you should disable product P1 module M1 from 8am to 6PM to lower computational costs, because module M1 primarily covers attack model constituent C1 and historically the attacks involving C1 occur at night”); or initiating 934 a security product status 510, 522 optimization based on at least the security coverage map 230 and a resource constraint 634 (e.g., the embodiment proactively implements the optimization instead of merely recommending it; an embodiment may dynamically detect coverage gaps and add or remove detection product functionality based on the load or resources of the SOC).

Although teachings disclosed herein may be beneficially applied in variously sized computing environments 100, one of skill will acknowledge a potential for particularly efficient use in “large” computing environments. In some embodiments and circumstances, the method 900 is further characterized in at least one of the following ways which indicate performance in a large environment: the method gathers 802 security activity data from at least five customer environments 218, each of which has at least one hundred user accounts 630; the method gathers 802 security activity data which represents at least one hundred thousand events 320 which occurred within period of no more than forty-eight hours; or the method gathers 802 security activity data which represents events 320 which occurred on at least one hundred different devices 102.

### Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as security coverage management software 302, gathered 802 security activity data 226, coverage map 230 data structures, mapping mechanisms 316, entity profiles 636, or installation counts 706, in the form of data 118 and instructions 116, read from a removable storage medium 114 and/or another source such as a network connection, to form a configured storage medium. The configured storage medium 112 is capable of causing a computer system 102 to perform technical process steps for security coverage management, as disclosed herein. The Figures thus help illustrate configured storage media embodiments and process (a.k.a. method) embodiments, as well as system and process embodiments. In particular, any of the process steps illustrated in FIGS. 8 or 9, or otherwise taught herein, may be used to help configure a storage medium to form a configured storage medium embodiment.

Some embodiments use or provide a computer-readable storage device 112, 114 configured with data 118 and instructions 116 which upon execution by at least one processor 110 cause a computing system to perform a method for managing cybersecurity coverage. This method includes: gathering 802 security activity data produced by at least two concurrently functional installations of a security product, each installation installed in a different respective environment of the observed computing system; deriving 804 a security coverage map from the gathered security activity data, the deriving including attempting to match at least a portion of the gathered security activity data to at least one cybersecurity attack model constituent; and operationalizing 806 the security coverage map, thereby enhancing 808 cybersecurity of at least one computing system.

In some embodiments, operationalizing 806 the security coverage map includes computationally comparing 916 at least two customer environments 218 with respect to at least three of the following characteristics: a customer industry 604; a customer size 606; a customer security operations center capacity 612; an extent of web endpoints 614 in an environment; an extent of internet of things 618 in an environment; an extent of mobile devices 622 in an environment; an extent of industrial control systems 626 in an environment; a presence or an absence of a particular application 132 in an environment; or a cloud service provider 608 utilized in an environment.

In some embodiments, operationalizing 806 the security coverage map includes proactively initiating 934 a security product operation status change 524 based on the security coverage map, or a security product installation status change 512 based on the security coverage map, or both.

In some embodiments, operationalizing 806 the security coverage map includes at least one of the following. displaying 910 a security coverage of a specified security product 220, wherein the security coverage is computationally derived 804 from the gathered security activity data as opposed to being based on product documentation or on human-created product reviews; or displaying 910 a security coverage of the cybersecurity attack model constituent 304 by one or more products, wherein the security coverage is computationally derived 804 from the gathered security activity data as opposed to being based on product documentation or on human-created product reviews.

In some embodiments, the method further includes cloaking 712 environment-product data 118, wherein the environment-product data states that a given security product 220 is installed in a given environment 218.

### Additional Observations

Additional support for the discussion of security coverage management functionality 210 herein is provided under various headings. However, it is all intended to be understood as an integrated and integral part of the present disclosure’s discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, additional examples and observations are offered.

Operation, capabilities, and usage of functionality 210 is further illustrated in the following scenarios. This is not a complete list of all scenarios in which teachings provided herein may be beneficially applied.

Scenario One (misconfiguration detected, products compared). Product P1 is installed in customer environments E2, E3, E4, and E5. Competing product P2 is installed in E1. The coverage map 230 shows good coverage of constituent C1 in E1, E2, E4, and E5 but not in E3. Investigation reveals a misconfiguration in E3, and after that is corrected, an updated coverage map 230 shows good coverage of C1 in E1, E2, E3, E4, and E5. Notice that products P1 and P2 each cover C1 in this scenario.

Scenario Two (coverage gap detected and filled). Product P1 is installed in customer environments E2, E3, E4, E5. The coverage map 230 shows good coverage of constituent C1 in E2, E3, E4, and E5, but no coverage of C1 in E1. In view of this, product P1 is installed in E1. An updated coverage map 230 shows good coverage of C1 in E1, E2, E3, E4, and E5.

Scenario Three (documentation error detected, coverage gap detected, then filled by different product). Product P1 is installed in customer environments E1, E2, and E3. Product documentation for P1 lists coverage of C1 as a benefit. The coverage map 230 shows weak coverage of constituent C1 in E1, and no coverage of C1 in E2 or E3. In view of this, P1 is uninstalled from E1, E2, and E3, and product P2 is installed in E1, E2, and E3. An updated coverage map 230 shows good coverage of C1 in E1, E2, and E3.

Scenario Four (duplicate coverage detected and removed). Products P1 and P2 are each installed in customer environment E1. P1 is also installed in E2 and E3. P2 is also installed in E4 and E5. The coverage map 230 shows coverage of all constituents of interest in E1, E2, E3, E4, and E5. The system 202 recommends 906 removal of either P1 or P2 from E1. P2 is removed. Thus, P1 remains in E1, E2, and E3, and P2 remains in E4 and E5. An updated coverage map 230 shows there is still coverage of all constituents of interest in E1, E2, E3, E4, and E5.

Scenario Five (environment expanded, attack model added, coverage gap detected and filled). A coverage map M1 for an enterprise cybersecurity attack model 228 shows coverage of all constituents 304 of interest in customer environments E1 and E2, which are business enterprise environments 218. E1 is expanded to include an industrial control computing system 626. A coverage map M2 for an industrial control system cybersecurity attack model 228 then shows coverage gaps for E1. An industrial control system cybersecurity attack coverage map 230 is not made for E2 because E2 has no industrial control system portion. After a combination of product setting changes 524 and product additions 512 in E1, updated coverage maps 230 show coverage of all constituents of interest in E1, both for the business enterprise portion of E1 and for the industrial control system portion of E1.

Cloud Knowledge. Some embodiments provide or utilize a system 202 or method 900 to utilize cloud knowledge to increase protection coverage. That is, data 226 from multiple environments 218 within a cloud 134 are gathered 802 and processed 804, 806 to enhance 808 security of at least a portion of the cloud 134.

One of the challenges security admins are facing is managing and tracking the cybersecurity protection coverage of their organization. A common best practice to manage the coverage is to follow the MITRE ATT&CK® matrix (mark of The MITRE Corporation). The matrix models cyber adversary behavior, reflecting the phases of an attack lifecycle and the platforms targeted. Better tactics and techniques coverage means better protection. Therefore, security admins may try to continuously track their environments, and may add more analytics or detections via more security products, in order to improve their security posture by increasing their matrix 228 coverage.

However, some security products do not report their MITRE matrix coverage. Most if not all that do report such coverage also frequently change their detections, making the available documentation obsolete. Accordingly, a user can only reliably determine the security coverage improvement after acquiring, installing, and running the product themself. Making an informed decision based on product documentation, reviews, or anecdotes is not feasible.

Some embodiments disclosed herein utilize cross-customer information to learn about the coverage 206 provided by different security products. Some embodiments include a Data Collector 322 that collects 802 alerts of multiple customers from the various security products available in the SIEM and sends them to a Coverage Estimator 324. The Data Collector may run periodically (e.g., daily or weekly) to collect alerts from some or even all customers.

Some embodiments require customer opt-in. Some provide a privacy toggle which allows a customer to opt-out from its alerts being collected 802, with the caveat that the resultant failure to contribute data 226 may limit or eliminate the availability of coverage information 230 to that customer.

In some embodiments, the Coverage Estimator aggregates 802 the alerts and produces a distinct list 230 such as one with Product I Alert type | Severity I Technique | Tactic and a counter for each combination. This is one suggested format; other mapping mechanism schemas are also allowed in some embodiments. The coverage Estimator may use technique and tactic information from all alerts. In some, a mapping mechanism configuration is loaded to further define the coverage. For example, the configuration can specify that a low severity alert is not considered evidence of coverage. Another example is a rule that an alert will be considered as evidence of coverage only if it was observed in N different customer environments, where N is in a range from three to ten. Fewer than three environments permits too many false positives, and more than ten is inefficient.

The security coverage map can be used to answer various questions. For instance, one could ask “Which Techniques are covered by the product ContosoGuard?” or one could ask “Which Tactics are covered by the product FabrikamAV?” That is, a user could choose a product 220 and be shown the corresponding Techniques or Tactics based on observed alerts. Conversely, a user could choose a Technique or a Tactic and be shown the corresponding products. That would answer a question such as “Which Tactics have no coverage?” or “Which Techniques are covered by more than one product?”

The coverage calculation result 230 may be sent to a front-end component 1000 which presents the results to the customer. FIG. 10 shows one of many suitable user interfaces 1000 for a given security coverage management program 302. For clarity and conformance with patent disclosure format requirements, text is stylized in FIG. 10 by virtue of being represented as line segments. The particular fonts, font sizes, colors, natural language texts, and programming language texts used may vary in an embodiment or vary across embodiments.

In this FIG. 10 example, a title 1002 identifies a software 302 vendor, and a framework 228 currently displayed, e.g., “Microsoft Sentinel | Mitre” (marks of their respective owners). Other title 1002 content may also be used.

A menu bar, navigation bar, set of tabs, or another navigation mechanism shows navigation items 1004 such as “Search by technique”, “Active products”, “Active NRT query rules” (NRT means near-real-time), “Simulate”, and so on. A dropdown menu may list security products 220 to present coverage info 230 about, e.g., “MS Defender for Identity″, MS Defender for loT”, “MS Defender for Endpoints”, and so on (MS stands for Microsoft), or SIEM components, e.g., “Analytic rule templates”, “Hunting queries”, and so on. Other navigation items 1004 may also be used.

A set of technique 304, 308 titles 1006 shows techniques specific to the framework 228 currently displayed, e.g., “Reconnaissance”, “Resource Development”, “Initial Access”, “Execution”, “Persistence”, and so on for this particular Mitre framework (The Mitre Corporation provides multiple frameworks). Other constituent 304 titles may be displayed for other frameworks 228.

A set of options 1008 in the leftmost column is topped by a Search item 1004, and includes hierarchies of options 1008 such as: “General” above “Overview”, “Logs”, “News & guides”, “Mitre”; “Threat management” above “Incidents”, “Workbooks”, “Hunting”, “Notebooks”, “Entity behavior”, “Threat intelligence”; “Content management” above “Content hub”, “Repositories”, “Community”; “Configuration” above “Data connectors”, “Analytics”, “Watchlist”, “Automation”, “Settings”, and so on. These are merely examples, not a complete list of options 1008.

A set of tactic 304, 306 blocks 1010 may include tactic 306 titles, e.g., under “Resource Development” 1006 one may see the tactic titles “Acquire Infrastructure”, “Compromise Accounts”, “Compromise Infrastructure”, “Develop Capabilities”, “Establish Accounts”, “Obtain Capabilities”, and “Stage Capabilities”. Other tactic 306 titles would appear under other technique titles 1006. Tactic blocks 1010 or other constituent visual representations may be colored to indicate coverage 206, e.g., blue background blocks have coverage and white background blocks do not have coverage. Values such as the strength of coverage, number of products providing coverage, or relative priority of covering that tactic may also be displayed, e.g., as numbers in corners of the corresponding block 1010.

### Technical Character

The technical character of embodiments described herein will be apparent to one of ordinary skill in the art, and will also be apparent in several ways to a wide range of attentive readers. Some embodiments address technical activities such as gathering 802 security alerts 410 from multiple cloud environments 218, mapping 316 alerts to cyberattack frameworks 228, and recommending 518 changes to an environment’s security posture, which are each an activity deeply rooted in computing technology. Some of the technical mechanisms discussed include, e.g., mapping mechanisms 316, SIEMs 722, and security coverage management software 302. Some of the technical effects discussed include, e.g., coverage maps 230 derived from security activity data 226 rather than product documentation 124 or product reviews 130, environment 218 comparison 916 results, reduced resource 632 consumption from the identification of duplicate coverage 206, enhanced security 216 from the identification and coverage of security gaps 514, and more focused security product 222 selection and configuration based on data 230 indicating which attack model constituents 304 are employed by which adversaries. Thus, purely mental processes and activities limited to pen-and-paper are clearly excluded. Other advantages based on the technical characteristics of the teachings will also be apparent to one of skill from the description provided.

Different embodiments may provide different technical benefits or other advantages in different circumstances, but one of skill informed by the teachings herein will acknowledge that particular technical advantages will likely follow from particular innovation features or feature combinations.

For example, gathering 802 security activity data 226 from multiple customer environments 218 provides more comprehensive and accurate assessments of the coverage 206 capability of a given product 220 relative to a particular adversary or particular customer profile characteristics, especially when the alternative is a reliance on vendor descriptions, or when the product is not currently installed in a particular environment 100 of interest. In this context, cloaking 712 data provides a privacy benefit without preventing the improved assessments of product coverage capabilities.

Proactively initiating 908 a security posture change 524 or 512 provides a faster response to an attack than waiting for human action. The faster response tends to limit the damage from the attack. The response may be implemented, e.g., by a SOAR tool whose action is triggered by a low coverage indication in a derived 804 coverage map 230.

Gathering 802 security activity data 226 which is generated 920 by a penetration test or other simulated attack and then deriving 804 a coverage map 230 based at least in part on that prompted data permits the testing of cloud-wide security products, e.g., those which are designed to protect cloud service provider infrastructure, with low and controlled risk to cloud customers, in order to enhance the security of all cloud customers.

Other benefits of particular steps or mechanisms of an embodiment are also noted elsewhere herein in connection with those steps or mechanisms.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how a given customer can reliably assess the security coverage of a product without actually installing the product. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples, operating environments, peripherals, kinds of security, kinds of data, time examples, software process flows, security tools, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
GUID: globally unique identifier
IaaS or IAAS: infrastructure-as-a-service
ID: identification or identity
LAN: local area network
OS: operating system
PaaS or PAAS: platform-as-a-service
RAM: random access memory
ROM: read only memory
SIEM: security information and even management, or tool for the same
SOAR: security orchestration and automated response, or tool for the same
TPU: tensor processing unit
UEFI: Unified Extensible Firmware Interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (laaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person’s mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Security coverage management operations such as gathering 802 data 226, deriving 804 a map 230 from data 226, and many other operations discussed herein, are understood to be inherently digital. A human mind cannot interface directly with a CPU or other processor, or with RAM or other digital storage, to read and write the necessary data to perform the security coverage management steps taught herein even in a hypothetical prototype situation, much less in an embodiment’s real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph / Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court’s legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure’s text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as nonoverlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as associating, cloaking, comparing, delimiting, deriving, displaying, enhancing, excluding including, initiating, gathering, mapping, matching, operationalizing, predicting, recommending, satisfying, simulating, weighting (and associates, associated, cloaks, cloaked, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person’s mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### List of Reference Numerals

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102 whose data and other resources are owned by a single entity - there is exactly one entity per environment; although a given entity may have multiple environments, a given environment has only one entity except for expressly multi-entity environments such as a cloud 134
102 computer system, also referred to as a “computational system” or “computing system”, and when in a network may be referred to as a “node”
104 users, e.g., user of an enhanced system 202; refers to a human or a human’s online identity unless otherwise stated
106 peripheral device
108 network generally, including, e.g., LANs, WANs, software-defined networks, clouds, and other wired or wireless networks
110 processor; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102
120 kernel(s), e.g., operating system(s), BIOS, UEFI, device drivers
122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, applications (e.g., word processors, web browsers, spreadsheets, games, email tools, commands), and so on
124 product documentation, e.g., user manuals, configuration guides, tutorials, spec sheets, white papers, provided with a product license or making authorized use of product vendor trademarks, for example
126 display screens, also referred to as “displays”
128 computing hardware not otherwise associated with a reference number 106, 108, 110, 112, 114
130 product reviews; unlike product documentation, reviews of a product are not created by the product’s vendor
132 application, with particular attention to large or specialized applications such as databases, customer relationship management tools, or software-as-a-service applications; digital
134 cloud, cloud computing environment; unless stated otherwise, clouds are multitenant and thus include multiple environments 218
202 system 102 enhanced with security coverage management functionality 210
204 cybersecurity as opposed to physical security
206 coverage; may be used herein to mean that some protection against a cybersecurity vulnerability is provided (e.g., as in “ContosoSentry covers lateral movement”), or may be used more generally to mean the status of such protection (e.g., as in “What’s the coverage of privilege elevation in this environment?”)
208 coverage management, e.g., determining which products provide which coverage in which environment and taking action in response, e.g., to cover gaps, reduce duplicate coverage, track coverage over time, and so on
210 security coverage management functionality, e.g., functionality which performs at least steps 804 and 808, or at least steps 804 and 806, or software 302, or an implementation providing functionality for any previously unknown method or previously unknown data structure shown in any Figure of the present disclosure
212 observation of a system or a system’s environment, e.g., gathering data 118 about the object of observation or reviewing or analyzing previously gathered data 118 about the object of observation; refers to act of observing computationally
214 system 214, e.g., a system 102 that is or has been observed with respect to data 226
216 security of a system 102, e.g., absence or presence of security vulnerabilities in the system with regard to data confidentiality, data integrity, data availability, or data privacy
218 observed environment, e.g., an environment that includes at least one observed system 214
220 cybersecurity product or service
222 an installation of a product, or the action of installing the product; when a cloud includes multiple environments, each environment could have its own installation of a given product, e.g., environments E1 and E2 have a ContosoGuard installation but E3 does not
224 security activity; computational; e.g., the detection of an apparent attack, anomaly detection, generation of an alert, product installation, product reconfiguration e.g., by settings change or configuration file change, analysis or transmission of alert data or anomaly data, entry to a security log, and so on
226 data 118 representing security activity
228 cyberattack model, also referred to as an attack model or an attack framework; embodied in digital data structure(s)
230 coverage map; digital data structure(s); represents extent of coverage of at least one attack constituent, and may include related data such as the number of security product installations 222 the map is derived from, or the time frame of the data 226 the map is derived from
232 managed environment 100, e.g., an environment that includes at least one managed system 202
302 software which upon execution performs security coverage management, e.g., software which performs at least steps 802 and 804, or at least steps 804 and 806, or at least steps 804 and 808
304 constituent of an attack framework 228, e.g., a tactic or a technique in the MITRE ATT&CK® model 228 (mark of The MITRE Corporation), or one of {Reconnaissance, Weaponization, Delivery, Exploitation, Installation, Command & Control, Actions on Objectives} in the CYBER KILL CHAIN® model 228 (mark of Lockheed Martin Corporation), or one of {Spoofing identity, Tampering with data, Repudiation, Information disclosure, Denial of service, Elevation of privilege} in the STRIDE™ threat model (mark of Microsoft Corporation); other frameworks also have constituents
306 tactic constituent, e.g., in the MITRE ATT&CK® model 228
308 technique constituent, e.g., in the MITRE ATT&CK® model 228
310 alert data, e.g., an alert 410 itself or data around the alert such as when the alert was generated, which product generated the alert
312 anomaly data, e.g., an anomaly descriptor 414 itself or data around the anomaly descriptor such as when the anomaly descriptor was generated, which product generated the anomaly descriptor
314 event data generally; digital
316 computational mechanism for mapping between activity data 226 and attack constituents 304; normally maps at least from data 226 to constituents 304, but in some embodiments also maps from constituents 304 to data 226, e.g., constituent C7 is covered based on data 226 of alert types A1 and A7
318 interface generally; connects machines or software to one another
320 event; digital
322 data collector portion of some embodiments; part of software 302
324 coverage estimator portion of some embodiments; part of software 302
326 visualization or change initiation portion of some embodiments; part of software 302
402 field in an alert data structure
404 identifier of a constituent, e.g., index, name, GUID, or pointer
406 correspondence between one or more individual activity data 226 or one or more kinds of data 226, on the one side, and one or more model constituents 304, on the other side; implemented digitally
408 data structure representing at least one correspondence 406
410 alert; data structure; also referred to as alert descriptor; may refer to or rely on an underlying set of events or conclusions
412 alert type; digital value; distinguishes, e.g., between different circumstances that may give rise to respective different kinds of alerts 410
414 anomaly; data structure; also referred to as anomaly descriptor; may refer to or rely on an underlying set of events or conclusions
416 anomaly type; digital value; distinguishes, e.g., between different circumstances that may give rise to respective different kinds of anomalies 414
418 relative priority of a constituent 304, e.g., tampering with data may be considered a higher priority constituent than denial of service
502 security product identifier, e.g., name or license number; may include version info, vendor ID, install date, and other data; digital
504 estimate of an extent to which the security product would cover a cybersecurity attack model constituent; digital
506 constituent coverage indicator which indicates an extent to which a cybersecurity attack model constituent is covered; digital; may be yes/no or have gradations such as low/medium/high, or be a percentage or a probability
510 security product installation status, e.g., installed or not installed; digital value
512 change to a security product installation status, e.g., installed yesterday, or no longer installed; represented digitally
514 gap in security coverage, e.g., lack of coverage or other vulnerability; represented digitally
516 security coverage change, e.g., closing a gap, opening a gap, reducing number of covering products; represented digitally
518 recommending one or more changes to an environment’s security posture, e.g., to close a gap or reduce coverage duplication; performed computationally
520 operation of a product, e.g., execution of the product in a computing system; performed computationally
522 operational status of a product, e.g., whether it is enabled, whether it is executing, what scope of a system is being operated on by the product
524 product operation status change, e.g., reconfiguration; represented digitally
602 customer, tenant, or other entity which owns or legally controls a system; not an individual human; “customer” and “entity” are used interchangeably in a broad sense, however, an individual human person is not an entity
604 customer industry, e.g., airline, hospital, law enforcement, and so on; represented digitally
606 customer size, e.g., in terms of employees, regions, users, transactions, or other quantities; represented digitally
608 service provider, especially cloud service provider
610 security operations center
612 customer security operations center capacity, e.g., number of personnel in response team, processing capability of SIEM, average response time, or another measure
614 web endpoint; digital
616 extent of web endpoints 614 in an environment, e.g., number of endpoints; represented digitally
618 internet of things device
620 extent of internet of things devices in an environment, e.g., number of loT devices or geographic area of devices; represented digitally
622 mobile device, e.g., smartphone, tablet, laptop, wearable device
624 extent of mobile devices in an environment, e.g., number of mobile devices or geographic area of devices; represented digitally
626 industrial control system, e.g., for manufacturing, utilities, military, and so on
628 extent of industrial control system in an environment, e.g., number of machines or nodes or geographic area; represented digitally
630 user account, e.g., for an individual person or a service; digital artifact
632 resource, e.g., file or other digital storage item, virtual machine or other digital artifact, application or other tool 122, kernel 120, portion of memory 112, processor 110, display 126 or peripheral 106 or other hardware 128; any computational item susceptible to attack 718 or coverage 206 in a system qualifies as a resource of that system; humans and other living beings, abstract ideas, and non-technical items are not resources 632
634 resource constraint; represented digitally
636 customer profile; digital data structure
702 alert severity; digital value
704 alert confidence; digital value
706 installation count; digital value
708 false positive, e.g., an alert that does not indicate an attack
710 false positive measure, e.g., calculated by a SIEM based on admin feedback about alerts; digital value
712 computationally cloaking data; 712 also refers to cloaked data
714 weight accorded to data; digital value
716 computationally simulated an attack, e.g., by penetration testing
718 attack, also referred to as cyberattack
720 normal execution, as opposed to execution with a debugger
722 SIEM; software
800 flowchart; 800 also refers to security coverage management methods illustrated by or consistent with the FIG. 8 flowchart
802 computationally gather data 226, e.g., using APIs, SIEMs, log reads, and other computational resources
804 computationally derive a coverage map 230 based on data 226, e.g., using a mapping mechanism 316 and optionally rules about what data 226 qualifies as evidence of coverage
806 computationally operationalize a map 230 or portion thereof
808 computationally enhance security as a result of operationalization
900 flowchart; 900 also refers to security coverage management methods illustrated by or consistent with the FIG. 9 flowchart (which incorporates the steps of FIG. 8)
902 computationally predict a security coverage change, e.g., by comparing environments in which a product is installed E1, E2 or not installed E3 and inferring whether the product will provide similar coverage behavior if installed in E3
904 computationally delimit a gap 514 in security coverage 206 based on a security coverage map
906 computationally infer and recommend a security coverage change
908 computationally initiate a security product operation status change
910 computationally display a security coverage, e.g., as in FIG. 10
912 computationally attempt to match data 226 to a constituent 304; information about coverage is provided by the attempt whether a match is found or not
914 computationally match data 226 to a constituent 304
916 computationally compare two environments, e.g., as to whether the sizes are similar, whether particular applications are present, whether they use the same laaS service provider, and so on
918 computationally weight data 226
920 computationally generate data 226
924 include data 226 in derivation 804 or other functionality 210 computation
926 computationally exclude non-cloaked data, or computationally avoid inclusion of non-cloaked data
928 computationally avoid configuring display 126 with non-cloaked data
930 computationally note a difference between a vendor description or a review, on the one side, and a coverage map 230, on the other side, or computationally configure a display 126 or other human-perceptible output with information describing a coverage map that differs from coverage asserted in a vendor description or a review
932 computationally compute and recommend an optimization, e.g., to cover a gap or reduce duplicate coverage or reduce coverage during periods when data shows a very low risk of attack
934 computationally compute and initiate an optimization, e.g., by covering a gap or reducing duplicate coverage or reducing coverage during periods when data shows a very low risk of attack; may be subject to override by an admin
936 computationally satisfy criterion 938, e.g., as to any aspect of a profile 636
938 criterion specifying an aspect of an environment, e.g., as to service provider, customer size, and so on; represented digitally
940 computationally simulate a product change or reconfiguration, e.g., if P1 is installed in E2 and behaves as P1 has recently behaved in E1, then coverage in E2 will change as follows, and so on
942 computationally configure a display screen, printer, speaker, or other device that produces human-readable or other human-perceptible output
944 message, e.g., text or graphics on a screen or paper, email, text, speech; represented digitally
946 computationally associate a coverage priority with a constituent
948 computationally undergo a penetration test or other simulated attack
950 any step discussed in the present disclosure that has not been assigned some other reference numeral
1000 software 302 user interface example; stylized
1002 software 302 title in user interface
1004 software 302 navigation item in user interface
1006 software 302 constituent title in user interface
1008 software 302 control item in user interface
1010 software 302 constituent representation in user interface

### Conclusion

In short, the teachings herein provide a variety of security coverage management functionalities 210 which operate in enhanced systems 202. Some embodiments gather 802 security activity data 226 from multiple environments 218 instead of only a single environment. Activity data 226 may include alerts data 310, anomaly detections data 312, and data 314 from defensive actions taken automatically in response to actual or simulated 716 attacks 718. Data 226 is cloaked 712 to protect privacy. Security product 220 coverage 206 of techniques 308, tactics 306, procedures, threat categories, and other constituents 304 of a cyberattack model 228 is derived 804 from the activity data 226 via a mapping mechanism 316, thereby allowing subsequent product installation changes 512 or operation changes 524 to be based on actual recorded responses 226 of products 220 to attacks 718. Coverage results 230 may be operationalized 806 as recommendations 518 or as proactive automated initiatives 908. Security 216 is enhanced 808 on the basis of data 226 which extends beyond the data available to any single cloud tenant 602.

Embodiments are understood to also themselves include or benefit from tested and appropriate security controls and privacy controls such as the General Data Protection Regulation (GDPR), e.g., it is understood that appropriate measures should be taken to help prevent misuse of computing systems through the injection or activation of malware in documents. Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 8 or 9 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A managed computing system which is configured for managing cybersecurity coverage, the managed computing system comprising:
a digital memory;
a processor in operable communication with the digital memory, the processor configured to perform cybersecurity coverage management steps including: (a) gathering security activity data produced by at least two concurrently functional installations of a security product, each installation installed in a different respective environment of an observed computing system, (b) deriving a security coverage map from the gathered security activity data, the deriving including attempting to match at least a portion of the gathered security activity data to at least one cybersecurity attack model constituent, and (c) operationalizing the security coverage map, thereby enhancing cybersecurity of at least one computing system.

2. The managed computing system of claim 1, further characterized in at least one of the following ways:
the managed computing system further comprises the gathered security activity data, and the gathered security activity data includes at least one of the following: security alert data, security anomaly data, or flagged security event data;
the managed computing system further comprises an attack model data structure representing a cybersecurity attack model which includes multiple cybersecurity attack model constituents; or
the managed computing system further comprises an attack model data structure representing a cybersecurity attack model which includes both technique constituents and tactic constituents.

3. The managed computing system of claim 1, further comprising a mapping mechanism which comprises at least one of the following:
a mapping field in the gathered security activity data which contains a cybersecurity attack model constituent identifier;
a correspondence structure which represents a correspondence between an alert type and a cybersecurity attack model constituent; or
a correspondence structure which represents a correspondence between an anomaly type and a cybersecurity attack model constituent.

4. The managed computing system of claim 1, further comprising the security coverage map, and wherein the security coverage map comprises:
a security product identifier which identifies the security product;
at least one of:
a cybersecurity attack model constituent coverage indicator which indicates an extent to which the security product covers the cybersecurity attack model constituent in the environments which include the concurrently functional installations of the security product, or
an estimate of an extent to which the security product would cover the cybersecurity attack model constituent in an environment which does not include any concurrently functional installation of the security product.

5. A method for managing cybersecurity coverage, the method performed by a computing system, the method comprising:
gathering security activity data produced by at least two concurrently functional installations of a security product, each installation installed in a different respective environment of an observed computing system;
deriving a security coverage map from the gathered security activity data, the deriving including attempting to match at least a portion of the gathered security activity data to at least one cybersecurity attack model constituent; and
operationalizing the security coverage map, thereby enhancing cybersecurity of the observed computing system, of a managed computing system, or both.

6. The method of claim 5, wherein operationalizing the security coverage map comprises at least one of the following:
predicting a security coverage change based on the security coverage map and a specified change to a security product installation status in a particular environment;
delimiting a gap in security coverage based on the security coverage map;
recommending a security coverage change based on the security coverage map;
recommending a security product installation status change based on the security coverage map;
proactively initiating a security product operation status change based on the security coverage map;
proactively initiating a security product installation status change based on the security coverage map;
displaying a security coverage of a specified security product, wherein the security coverage is derived from the gathered security activity data as opposed to being based on product documentation or on human-created product reviews; or
displaying a security coverage of the cybersecurity attack model constituent by one or more products, wherein the security coverage is derived from the gathered security activity data as opposed to being based on product documentation or on human-created product reviews.

7. The method of claim 5, wherein operationalizing the security coverage map comprises comparing at least two customer environments with respect to at least one of the following characteristics:
a customer industry;
a customer size;
a customer security operations center capacity;
an extent of web endpoints in an environment;
an extent of internet of things in an environment;
an extent of mobile devices in an environment;
an extent of industrial control systems in an environment;
a presence or an absence of a particular application in an environment; or
a cloud service provider utilized in an environment.

8. The method of claim 5, wherein deriving the security coverage map comprises at least one of the following:
weighting at least a portion of the gathered security activity data based on a severity measure;
weighting at least a portion of the gathered security activity data based on a confidence measure;
weighting at least a portion of the gathered security activity data based on a false positives measure; or
weighting at least a portion of the gathered security activity data based on an installation count.

9. The method of claim 5, further comprising generating at least a prompted portion of the security activity data by undergoing a simulated cyberattack, and including at least part of the prompted portion in the gathered security activity data.

10. The method of claim 5, further comprising cloaking confidential or proprietary information of a customer other than the given customer or environment-product data, wherein the environment-product data states that a given security product is installed in a given customer environment other than a given customer’s own customer environment, and wherein the cloaking includes at least one of the following:
cloaking at least a portion of the data prior to finishing gathering security activity data;
cloaking at least a portion of the data in the gathered security activity data;
avoiding inclusion of any non-cloaked data in the security coverage map;
avoiding displaying any non-cloaked data during normal execution.

11. The method of claim 5, wherein gathering security activity data includes at least one of the following:
gathering security activity data from a security information and event management system which monitors activities in multiple environments;
gathering security activity data from each of a plurality of security information and event management systems which each monitor activities in a respective single environment;
gathering security activity data from each of a plurality of agents which each monitor activities in a respective single environment; or
gathering security activity data from at least one specialized security product which monitors activities in a single environment.

12. The method of claim 5, wherein the method is performed by, or on behalf of, a cloud service provider which provides services to customers in a cloud, and wherein the environments from which security activity data is gathered include customer environments in the cloud.

13. The method of claim 5, wherein for a particular security product, the coverage map differs from a vendor description of the particular security product as to whether a particular cybersecurity attack model constituent is covered by the particular security product.

14. The method of claim 5, wherein operationalizing the security coverage map includes at least one of the following:
recommending a security product status optimization based on at least the security coverage map and a resource constraint; or
initiating a security product status optimization based on at least the security coverage map and a resource constraint.

15. The method of claim 5, further characterized in at least one of the following ways:
the method gathers security activity data from at least five customer environments, each of which has at least one hundred user accounts;
the method gathers security activity data which represents at least one hundred thousand events which occurred within period of no more than forty-eight hours; or
the method gathers security activity data which represents events which occurred on at least one hundred different devices.

16. A computer-readable storage device configured with data and instructions which upon execution by a processor perform a method for managing cybersecurity coverage, the method performed by a computing system, the method comprising:
gathering security activity data produced by at least two concurrently functional installations of a security product, each installation installed in a different respective environment of the observed computing system;
deriving a security coverage map from the gathered security activity data, the deriving including attempting to match at least a portion of the gathered security activity data to at least one cybersecurity attack model constituent; and
operationalizing the security coverage map, thereby enhancing cybersecurity of at least one computing system.

17. The storage device of claim 16, wherein operationalizing the security coverage map comprises computationally comparing at least two customer environments with respect to at least three of the following characteristics:
a customer industry;
a customer size;
a customer security operations center capacity;
an extent of web endpoints in an environment;
an extent of internet of things in an environment;
an extent of mobile devices in an environment;
an extent of industrial control systems in an environment;
a presence or an absence of a particular application in an environment; or
a cloud service provider utilized in an environment.

18. The storage device of claim 16, wherein operationalizing the security coverage map comprises proactively initiating a security product operation status change based on the security coverage map.

19. The storage device of claim 16, wherein operationalizing the security coverage map comprises at least one of the following:
displaying a security coverage of a specified security product, wherein the security coverage is computationally derived from the gathered security activity data as opposed to being based on product documentation or on human-created product reviews; or
displaying a security coverage of the cybersecurity attack model constituent by one or more products, wherein the security coverage is computationally derived from the gathered security activity data as opposed to being based on product documentation or on human-created product reviews.

20. The storage device of claim 16, wherein the method further comprises cloaking environment-product data, wherein the environment-product data states that a given security product is installed in a given environment.
